(19) United States
(12) Patent Application Publication
(10) Pub. No.: US 2022/0061263 A1
(43) Pub. Date: Mar. 3, 2022

(54) Pet Harness and Corresponding Dog Carrying Backpack That Can Be Stored and Carried By a Dog

(71) Applicant: K9 Sport Sack LLC, Orem, UT (US)

(72) Inventor: Joseph Watson, Orem, UT (US)

(21) Appl. No.: 17/404,957

(22) Filed: Aug. 17, 2021

Related U.S. Application Data
(63) Continuation-in-part of application No. 17/008,479, filed on Aug. 31, 2020.

(51) Int. Cl. A01K 1/02; A01K 27/00

(52) U.S. Cl. CPC A01K 1/0254; A01K 1/0263; A01K 27/002; A01K 27/008

(57) ABSTRACT

A system for walking and carrying a pet can include a harness configured to be worn by the pet; a clip-on bag that is selectively attachable to and removable from the harness to be carried by the pet; and a pet carrying backpack configured to be stored within the clip-on bag to be carried by the pet. The pet carrying backpack includes a pet compartment configured to carry the pet.

### CROSS REFERENCE TO RELATED APPLICATION

This is a continuation-in-part of U.S. patent application Ser. No. 17/008,479 which was filed on Aug. 31, 2020, the contents of which are hereby incorporated by reference.

### BACKGROUND

Many people enjoy keeping pets for the companionship, help, and/or friendship that they provide. Pets, of course, require substantial time and care from their owners to ensure that they are well cared for. Sometimes, pet owners would like to travel, hike, or participate other activities which their pets are not capable of due to the pet's size, age, or various health issues. Many pet owners also prefer not to leave their pets in the care of friends or commercial pet care facilities while participating in such activities. Accordingly, such pet owners are need of a solution that allows them to participate in activities they find enjoyable while being able to bring along their pet companions that may not otherwise be capable of joining with them.

### SUMMARY

According to one example, a pet carrying backpack includes a bottom panel, a front panel, a rear panel, a right-side panel, and a left-side panel connected together to form a bag with an open top. The open top includes a collar forming an opening which is configured to allow a head of an animal disposed within the bag to protrude therefrom. The collar can be adjustable to facilitate animals of different sizes, and to allow for easy loading and unloading of the animal.

The pet carrying backpack can further include shoulder straps disposed on and extending from the front panel, and paw holes disposed on a front of the backpack body above the shoulder straps and below the collar. The paw holes can accommodate paws or legs of the animal. A pet carrying platform can be disposed within the bag above the bottom panel and below the open top. The pet carrying platform can thus form a storage compartment below the pet carrying platform and a pet compartment above the pet carrying platform within the bag.

In another example, the pet carrying backpack can include at least one contouring strap that is configured to shape the bag. A vertical zipper can be disposed in the back panel. The zipper facilitates ingress and egress to and from the pet compartment. The contouring strap(s) can include at least one lumbar support strap that is disposed on the backpack to cross over the vertical zipper. The lumbar support strap(s) can extend across the rear panel and attach to the backpack at scams between the rear panel and the side panels.

In one example, the at least one contouring strap includes at least one adjustment strap disposed over at least one of the right-side panel and the left-side panel. The at least one adjustment strap can be oriented diagonally relative to a seam between the front panel and the right-side panel and/or the left-side panel. An angle of the diagonal orientation of the at least one adjustment strap can be between 25 degrees and 65 degrees.

In some examples, the pet carrying platform can be angled upwards from the front panel towards the rear panel. The angle of the pet carrying platform relative to a direction perpendicular to the front panel can be between 10 and 30 degrees.

In some examples, the pet carrying backpack includes waist straps. The waist straps can be connected to the bag adjacent to the storage compartment.

In some examples, there can be a set of pet carrying backpack where a first pet carrying platform of a first pet carrying backpack of the set is disposed at a first distance from a first bottom panel of the first pet carrying backpack and a second pet carrying platform of a second pet carrying backpack of the set is disposed at a second distance from a second bottom panel of the second pet carrying backpack, the second distance being greater than the first distance.

In another example, a pet carrying backpack includes a bottom panel, a front panel, a rear panel, a right-side panel, and a left-side panel connected together to form a bag with an open top. The open top includes a collar forming an opening which is configured to allow a head of an animal disposed within the bag to protrude therefrom. The collar can be adjustable.

The backpack further includes shoulder straps disposed on and extending from the front panel, and paw holes disposed on a front of the backpack body above the shoulder straps and below the collar. The paw holes accommodate paws or legs of the animal. A harness can also be included and is configured to be worn by the animal and to be removably connectable to the bag.

The harness can include a chest portion where the chest portion has an attachment mechanism. The attachment mechanism can be configured to attach to and detach from the front panel of the bag. In some instances, the attachment mechanism attaches to the front panel of the bag between the paw holes. The harness can also include storage bag clips configured to receive a storage bag to be worn by the animal.

In some examples, an I-shaped access zipper can be disposed on the back panel. The I-shaped access zipper provides ingress to and egress from the bag.

In another example, a pet carrying backpack includes a bottom panel, a front panel, a rear panel, a right-side panel, and a left-side panel connected together to form a bag with an open top. The open top includes a collar forming an opening which is configured to allow a head of an animal disposed within the bag to protrude therefrom. The collar can be adjustable. Shoulder straps can be disposed on and extending from the front panel, and paw holes can be disposed on a front of the backpack body above the shoulder straps and below the collar. The paw holes accommodate paws or legs of the animal.

The backpack can further include at least one pet pen portion disposed on one of the front panel and the rear panel. The pet pen portion is deployable to extend from a stored position to a deployed position to form at least a part of a pet pen.

The at least one pet pen portion can include a front pen portion disposed on the front panel and a rear pen portion disposed on the rear panel. The front pen portion can have a front pen release zipper which when unfastened allows the front pen portion to be deployed from the stored position to the deployed position, and the rear pen portion includes a rear pen release zipper which when unfastened allows the rear pen portion to be deployed from the stored position to the deployed position.

The rear panel can include at least one access zipper. The at least one access zipper can be disposed between the rear pen release zipper and a seam between the rear panel and at least one of the right-side panel and the left-side panel.

The at least one pet pen portion can include a mesh material allowing ventilation and visibility for the pet pen. The backpack can further include a base padding that has a bottom portion disposed in or adjacent to the bottom panel and at least one side portion being disposed in the at least one pet pen portion. The at least one side portion providing padding adjacent to the bottom portion when the at least one pet pen portion is in the deployed position.

According to another example of the present disclosure, a system for walking and carrying a pet is provided. The system can comprise a harness configured to be worn by the pet, a clip-on bag that is selectively attachable to and removable from the harness to be carried by the pet, and a pet carrying backpack configured to be stored within the clip-on bag to be carried by the pet. The pet carrying backpack can comprise a pet compartment configured to carry the pet.

In some examples, the harness can comprise an attachment mechanism configured to attach to and detach from a front panel of the pet carrying backpack. The attachment mechanism can be disposed on a chest portion of the harness.

In some examples, the system can comprise a pad configured to be disposed within the clip-on bag to pad the pet from the pet carrying backpack stored therein. The pad can also be configured to be disposed within the pet compartment to support the pet seated therein.

In some examples, the pet carrying backpack can comprise shoulder straps, an open top, and paw holes disposed on the backpack between the shoulder straps and the open top. The harness can a chest portion. The chest portion can comprise an attachment mechanism where the attachment mechanism can be configured to attach to and detach from a front panel of the pet carrying backpack. The attachment mechanism can attach to the front panel between the paw holes.

In one example, the pet carrying backpack can comprise a bottom panel, a front panel, a rear panel, a right-side panel, and a left-side panel connected together to form a bag with an open top. The open top can comprise a collar forming an opening which is configured to allow a head of the pet disposed within the bag to protrude therefrom. The collar can be adjustable. The backpack can further comprise shoulder straps disposed on and extending from the front panel, and paw holes disposed on a front of the backpack body above the shoulder straps and below the collar. The paw holes can be configured to accommodate paws or legs of the pet. The clip-on bag can be selectively attachable to and removable from the pet-carrying backpack.

In one example of the present disclosure, a method for walking and carrying a pet is provided. The method can include fitting a harness onto a pet, attaching a clip-on bag to the harness such that the pet carries the clip-on bag which is supported by the harness while the pet is walking, and removing a pet-carrying backpack from the clip-on bag, inserting the pet into the pet carrying backpack such that the pet is carried in the pet-carrying backpack.

In some examples, inserting the pet into the pet carrying backpack can further comprise attaching the harness to the pet carrying backpack via an attachment mechanism. The attachment mechanism can be disposed on a chest portion of the harness. A pad can be disposed in the clip-on bag to be adjacent to the pet when the clip-on bag is supported by the harness while the pet is walking. Inserting the pet into the pet carrying backpack can also comprise removing the pad from the clip-on bag and placing the pad into the pet-carrying backpack such that the pet sits on the pad while being carried in the pet-carrying backpack.

In some examples, the pet carrying backpack can comprise shoulder straps, an open top, and paw holes disposed on the backpack between the shoulder straps and the open top. Inserting the pet into the pet carrying backpack can further comprise leading paws or legs of the pet through the paw holes. The harness can comprise a chest portion and the chest portion can comprise an attachment mechanism. Inserting the pet into the pet carrying backpack can further comprise attaching the attachment mechanism to a front panel of the pet carrying backpack. The attachment mechanism can attach to the front panel between the paw holes.

In some examples, the method can further comprise removing the clip-on bag from the harness and attaching the clip-on bag to the pet-carrying backpack.

In another example of the present disclosure, a system for walking and carrying a pet can comprise a pet carrying backpack comprising a pet carrying compartment to carry a pet therein, and a harness configured to be worn by the pet. The harness can comprise an attachment mechanism operable to attach to and detach from the pet carrying compartment.

In some examples, the pet carrying backpack comprises shoulder straps, an open top, and paw holes disposed on the backpack between the shoulder straps and the open top, and the harness comprises a chest portion. The chest portion can comprise the attachment mechanism.

### BRIEF DESCRIPTION OF THE DRAWINGS

FIG. 1 shows a front perspective view of a front facing, pet carrying backpack according to one example of the present disclosure, and

FIG. 2 shows a rear perspective view of the pet carrying backpack of FIG. 1.

FIG. 3A and FIG. 3B show examples of front-facing pet carrying backpacks for differently sized pets that are waist-strap compatible. FIG. 3C shows a side cut-away view of the backpacks in FIG. 3A and FIG. 3B.

FIG. 4A shows a rear view of a front-facing, pet carrying backpack according to another example, and FIG. 4B shows a side view of the backpack of FIG. 4A.

FIG. 5 shows an enlarged view of the top of a front panel of the pet carrying backpack shown in FIGS. 4A and 4B.

FIG. 6A, FIG. 6B, FIG. 6C, and FIG. 6D show views of a front-facing, pet carrying backpack with a hood and hood storage, according to one example.

FIG. 7A shows an interior of a front-facing, pet-carrying backpack with a harness, according to one example, and FIGS. 7B, 7C, and 7D show another example of a harness compatible with a pet carrying backpack.

FIG. 8A, FIG. 8B, FIG. 8C, and FIG. 8D show examples of a front-facing pet carrying backpack that is convertible to a travel pet pen, according to one example.

FIG. 9 shows a base padding for a convertible pet backpack and pen, according to one example.

FIG. 10 shows another example of a pet harness that can be used with a pet-carrying backpack.

FIG. 11A shows a pet wearing a pet harness and carrying a clip-on bag, and FIG. 11B shows a pet being carried within a pet carrying backpack.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

Front Facing, Pet Carrying Backpacks

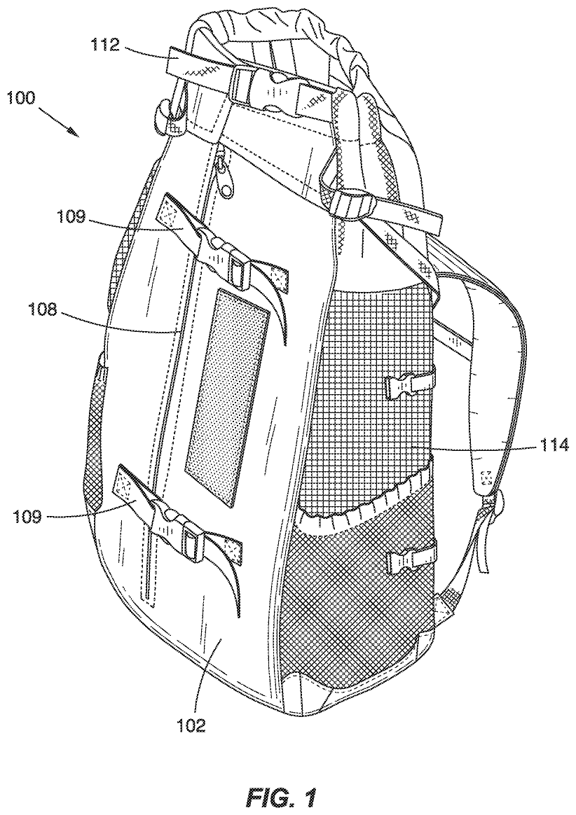

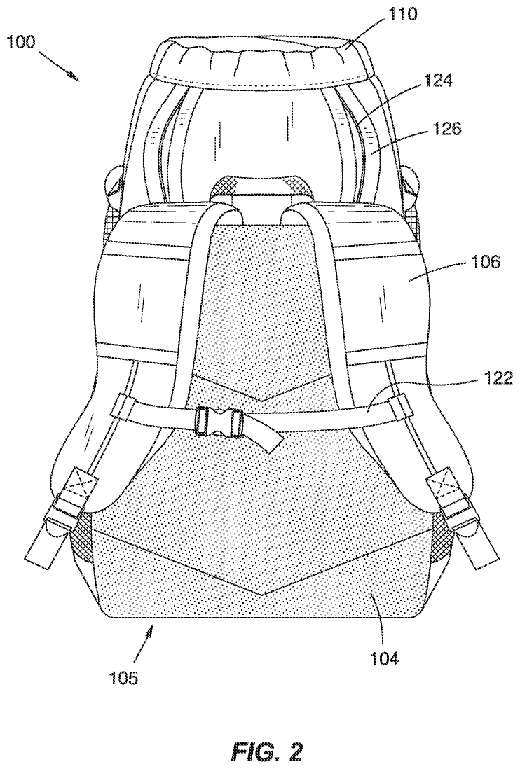

FIG. 1 shows a front perspective view of a front facing, pet carrying backpack according to one example of the present disclosure, and FIG. 2 shows a rear perspective view of the pet carrying backpack of FIG. 1. A pet carrying backpack 100 is formed from a front panel 104, a rear panel 102, two side panels 103, and a bottom panel 105.

The front panel 104 comprises shoulder straps 106 attached to the front panel 104 to facilitate the carrying of the backpack 100 on a user's shoulders. In some examples, a sternum strap 122 can be provided on the shoulder straps 106. On an upper portion of the front panel 104 above the shoulder straps 106, paw holes 124 are provided. The paw holes 124 allow the pet riding in the backpack 100 to face forward, that is face in same direction as the user wearing the backpack 100. In some examples, the paw holes 124 can be lined with a padded, elastic liner 126 that increases the comfort of the pet while the pet's paws extend through the paw holes 124.

The side panels 103 can be at least partially formed from a mesh material 114. The mesh material 114 allows air to ventilate into the interior of the backpack 100 to regulate the temperature of a pet riding therein. The side panels 103 can further comprise one or more pockets 116. Here, the pockets 116 are also formed at least partially from a mesh material so as not to impede air flow through the mesh 114 of the side panel 103. The side panels 103 can further comprise adjustment straps 118 which can be tightened and loosened to adjust the size of the interior of the backpack 100 to fit the pet riding therein. In one example, the adjustment strap 118 can be oriented diagonally with respect to the side panel 103. For example, the adjustment strap 118 can be oriented at an angle between 25 degrees and 65 degrees relative to a vertical edge 103a of the side panel 103. More preferable, the angle of the adjustment strap 118 relative to the vertical edge 103a of the side panel is between 35 and 55 degrees.

The rear panel 102 comprises an access zipper 108 that extends to the top of the backpack 100. When the access zipper 108 is open, wide and unobstructed access to the inside of the backpack 100 is provided. This allows easy loading and unloading of a pet riding in the backpack 100. Pet lumbar support straps 109 are provided and are attached to the rear panel 102 on both sides of the zipper 108. These provide added safety by taking the weight of the pet off of the zipper 108. The pet lumbar support straps 109 further provide lumbar support to the pet riding in the backpack 100. The contour of the interior of the backpack 100 can also be adjusted via the pet lumbar support straps 109.

In some examples, the lumbar support straps 109 are sewn to the rear panel 102. In other examples, the lumbar support straps 109 can extend and be attached at a seam 102a between the rear panel 102 and the side panels 103. This increases the surface coverage and stability provided by the lumbar support straps 109.

A collar 110 is provided at the top of the backpack 100 above each of the front, rear, and side panels 102, 103, 104. The collar 110 is adjustable by way of a collar adjustment strap 112. This allows the backpack 100 to be fitted around the neck of the pet to prevent the pet from jumping out of the backpack 100 during use.

When a pet is loaded into the backpack 100, the pet sits on the bottom panel 105 of the bag. The bottom panel 105 can be formed from a thick, padded material providing a sturdy and comfortable seat for the pet.

Other features of a front-facing, pet carrying backpack can also be provided. Such features are discussed in more detail in U.S. application Ser. No. 15/821,539 and in U.S. application Ser. No. 16/547,372, the contents each of which are hereby incorporated by reference.

Backpacks for Differently Sized Pets that are Waist-Strap Compatible

Front facing, pet-carrying backpacks are preferably provided in different sizes to accommodate differently sized pets. For a larger pet, the length, width, and height of the backpack are greater than a backpack design for a smaller pet. This is of course so that the pet fits comfortably within the backpack. For example, if the height of the backpack 100 is too long for a given pet, than the pet will not be able to sit on the bottom panel 105 of the backpack 100 with its paws through the paw holes 134 and its head above the collar 112. Thus, the backpack for this pet must be sized small enough so that the pet can comfortably ride in the backpack.

Many users of backpacks prefer a backpack design with a waist strap. Especially in applications where a user will carry a backpack for an extended time, a waist strap allows the user to transfer a large portion of the weight of the backpack from the user's shoulders to the user's hips. This makes the backpack much easier to carry, especially if carrying a heavier load or wearing the backpack over an extended time.

However, if a user of a front facing, pet-carrying backpack has a smaller pet, the backpack is typically sized such that the bottom panel, such as bottom panel 105 of the backpack 100, is located well above the user's waist. In this instance, a waist strap would not be compatible with the backpack 100.

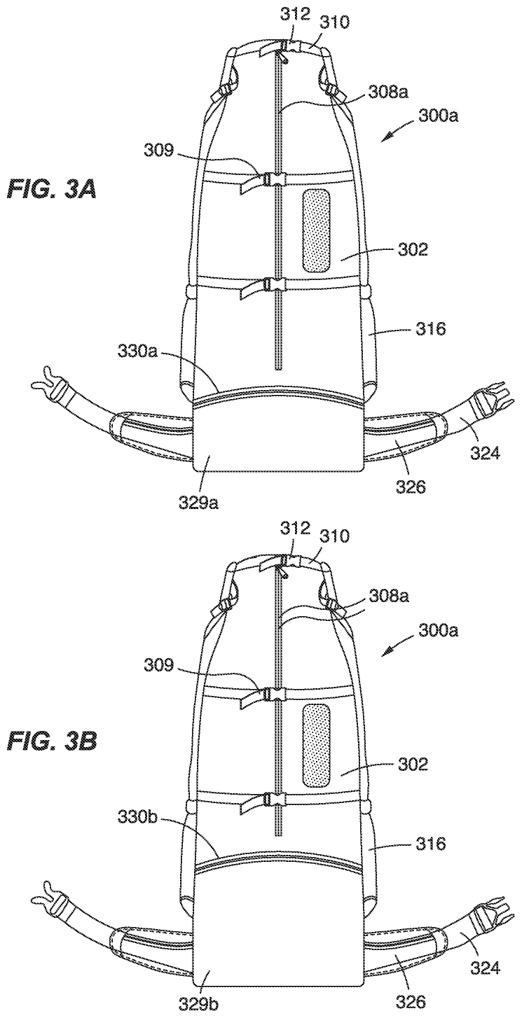

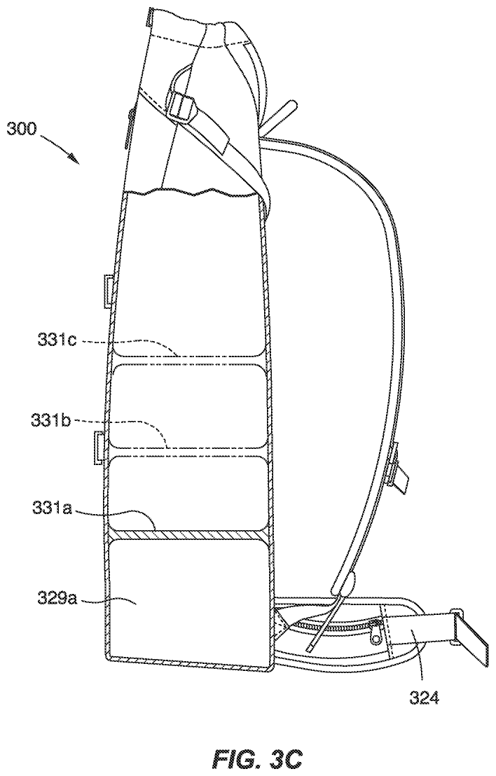

FIG. 3A and FIG. 3B show examples of front-facing pet carrying backpacks for differently sized pets that are waist-strap compatible. FIG. 3C is a side cut-away view of the backpacks in FIG. 3A and FIG. 3B. As shown in FIG. 3A, a front-facing, pet carrying backpack 300a includes several similar features as the backpack 100. For example, the backpack 300a includes a front panel 302 with an access zipper 308a and pet lumbar support straps 309. At the top of the backpack is a collar 310 with a collar adjustment strap 312. The backpack 300a can optionally have side pockets 316.

The backpack 300a is fitted with a waist strap 324. The waist strap 324 can be similar to other bags with waist straps. For example, the waist strap 324 can have a pocket 326 configured to hold small items so that they are easily accessible to the user. The waist strap 324 is configured to strap around a user's waist to transfer the weight of the backpack 300a to the user's hips.

The backpacks 300a includes the waist strap 324 while also being correctly sized for a particular sized pet. To achieve this, the backpack 300a includes a lower storage compartment 329a that is separated from the rest of the interior of the backpack 300a. The separation is created by the placement of the thick, padded seat 331a for the pet on the inside of the backpack (see FIG. 3C). The thick, padded seat 331a is not placed at the bottom of the bag to define the bottom panel 105 as in the backpack 100 (FIGS. 1 and 2). The thick padded seat 331a is disposed above the lower storage compartment 329a and forms the separation of the lower storage compartment 329a from the rest of the interior of the backpack 300a which holds the pet being carried. A lower zipper 330a provides access to the lower storage compartment 330a.

Through the placement of the thick, padded seat 331a, the backpack 300a can be sized for a particular sized pet while still being long enough so that the waist strap 324 comfortably extends around the user's waist. Using this arrangement, backpacks accommodating several different sizes of pets can be provided all while simultaneously remaining compatible with a waist strap 324.

FIG. 3B shows a backpack 300b. The backpack 300b is similar to backpack 300a except that the backpack 300b fits a smaller pet than the backpack 300a. The backpack 300b also includes a lower storage compartment 329b. However, the lower storage compartment 329b is larger than the lower storage compartment 329a. The lower zipper 330b providing access to the lower storage compartment 329b is disposed higher up on the backpack 300b, and the access zipper 308b is shorter. This is because the thick, padded seat 331b (see FIG. 3) is disposed higher in the backpack 300b, accommodating a smaller pet than the backpack 300a.

As shown in FIG. 3C, a thick padded seat 331a, 331b, 331c can be disposed at any desirable position in the backpack 300. This changes the relative sizes of the interior for the pet and the lower storage compartment 329a, allowing the backpack 300 to be sized to carry differently sized pets while still being compatible with the waist strap 324.

Various modification can be made in the backpack 300. For example, the backpack 300 can include an internal frame. The internal frame can also extend through the thick padded seat 331a, 331b. 331c to provide extra rigidity and comfort to the pet and the user. In some examples, the lower storage compartment 329a, 329b can be subdivided to include separate storage areas or pockets. In other examples, the placement of the lower zipper 330a. 330b on the bags 300a 300b can be in the same position between the differently sized bags for design consistency.

Angled Pet Support Surface

It has been found the many users of backpacks prefer to wear backpacks too loose. This may be because users prefer the straps loose enough to be able to quickly put on and remove the straps with little effort. Regardless, wearing a backpack too loosely can result in problems when wearing a pet carrying backpack.

When wearing a pet carrying backpack too loosely, the weight of the pet causes the backpack to sag. This results in the back of backpack being lower than the front of the backpack. When the back of the backpack is lower than the front, the bottom of the backpack is not flat. Instead the bottom of the backpack is angled down such that the pet sitting on the bottom of the backpack is slanted away from the user. This causes the weight of the pet to shift against the back panel of the backpack, decreasing the comfort and sense of security of the pet.

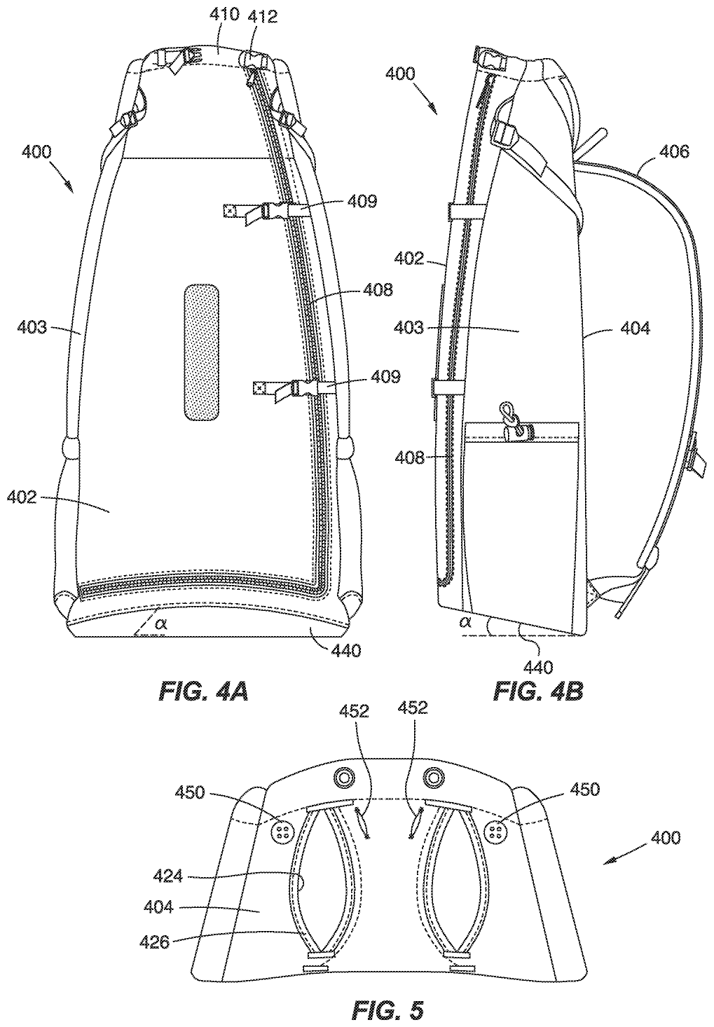

FIG. 4A shows a rear view of a front-facing, pet carrying backpack according to another example of the present disclosure, and FIG. 4B shows a side view of the backpack of FIG. 4A. A front-facing, pet-carrying backpack 400 is formed from a front panel 404, a rear panel 402, two side panels 403, and a bottom panel 440. In this example, the backpack construction is such that bottom panel 440 is angled upwards from the front panel 404 to the rear panel 402 as denoted by an angle α.

The angled bottom panel 400 ensures a comfortable and secure ride for a pet being carried in the backpack 400. The pet can comfortably sit with its weight towards the front panel 404 of the backpack 400 even if a user wears the shoulder straps 406 of the backpack 400 too loosely. An optimal angle α of the bottom panel 440 can be around 20 degrees. Preferably the angle is between 5 degrees and 45 degrees, and more preferably between 10 and 30 degrees. It should also be noted that while FIGS. 4A and 4B show the angled support surface built into the bottom panel 400, the angled support surface can be applied to an internal pet support surface such as padded seats 331a, 331b, and 331c shown above in FIG. 3C.

L-Shaped Zipper

The backpack 400 includes an access zipper 408. As shown in FIG. 4A, the access zipper 408 differs from the access zipper 108 in that the access zipper 408 runs along the side and bottom of the rear panel 402 of the backpack 400. The access zipper 408 allows almost the entire front panel 402 to fold over and away from the backpack 400. This allows unobstructed access to the interior of the backpack 400. This “L-shaped” access zipper 408 facilitates easy loading and unloading of a pet to be carried in the backpack 400.

For example, a pet can be more comfortable being loaded into the backpack 400 without the user holding the pet and lifting the pet into the backpack. This can be done by laying the backpack 400 on a flat surface with the front panel 404 facing down. The access zipper 408 can be completely opened and the front panel 402 can be folded away from the backpack 400. The pet can be led to sit or lie down in the interior of the backpack with the front panel 402 folded away. With the pet in position, the front panel can be put back into position by closing the access zipper 408 around the pet.

The backpack 400 further comprises pet lumbar support straps 409. Similar to the support straps 109, these straps are connected at both sides of the access zipper 408 to decrease the stress on the access zipper 408 and to correctly size the backpack 400 around the pet.

The “L-shaped” access zipper 408 provides other benefits. For example, with the vertical portion of the access zipper 408 being adjacent to one of the side panels 403, the zipper does not rest against the pet's spine during use. This increases the comfort of the backpack 400 for the pet, allowing the pet to comfortably spend more time in the backpack 400.

Adjustable Oval Paw Holes

FIG. 5 shows an enlarged view of the top of a front panel of the pet carrying backpack shown in FIGS. 4A and 4B. As shown in FIG. 5, the front panel 404 of the backpack 400 comprises paw holes 424. Unlike the paw holes 124, the paw holes 424 are formed or cut out of the front panel 404 to be open and rounded, forming an oval or pointed-oval shape. This shape prevents the paw holes 424 from irritating the pet's forelegs. To provide further comfort, the paw holes are surrounded by padded, elastic liner 426.

So that the backpack 400 can accommodate pets with differently sized forelegs, the paw holes 424 can be adjustable. For example, as shown in FIG. 5, a button 450 and corresponding button-hole 525 can be added to the front panel 404 of the backpack 400 to surround each paw hole 424. If the user desires to make the paw hole 424 smaller, the user simply closes up the top part of the paw hole 424 by fastening the button 450 in the button hole 452.

Of course, other fastener besides buttons can be used such as snapping fasteners, magnetic fasteners, hook and loop fasteners, etc. Further, more than one set of fasteners can be placed next to each paw hole 424. The fasteners can be placed adjacent to the top of the paw hole 424 or the bottom of the paw hole 424 to adjust the size of the paw hole 424.

Hood and Storage

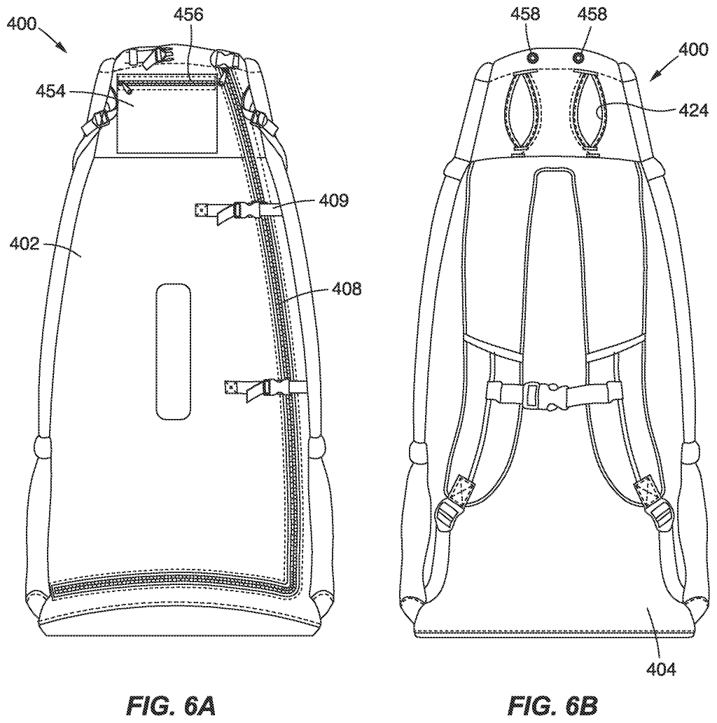

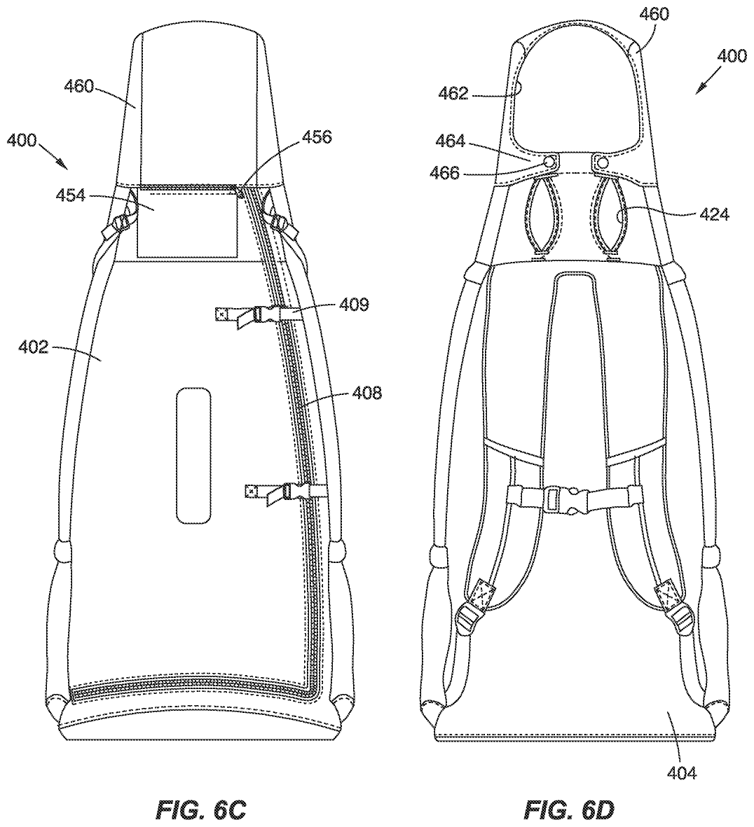

FIG. 6A, FIG. 6B, FIG. 6C, and FIG. 6D show views of a front-facing, pet carrying backpack with a hood and hood storage, according to one example. FIG. 6A shows a rear view of the backpack 400. Here, the backpack 400 is fitted with a hood. The hood is stored in a hood storage compartment 454 on an upper portion of the rear panel 402. The L-shaped zipper 408 provides adequate space for the placement of the hood storage compartment 454 on the rear panel 402. A zipper 456 is provided to control access to the hood storage compartment 454.

As shown in FIG. 6B, on a top portion of the front panel 404 there are two snap fasteners 458. As will be described below, the snap fasteners 458 facilitate the placement of the hood over a pet during use.

FIG. 6C shows a rear view of the backpack 400 with the hood 460 deployed. The hood 460 can be deployed out from the hood storage compartment 454 by opening the zipper 456. The hood 460 can be permanently attached to the backpack 400 inside the hood storage compartment 454, such as by stitching.

FIG. 6D shows a front view of the backpack 400. Here the hood 460 is shown in a deployed position. The hood 460 includes a front opening 462 through which a pet is able to see out while the hood 460 is in use. At the bottom of the opening 462, two tabs 464 are provided that extend around the top of the front panel 404. The tabs 464 include snap fasteners 466 that correspond to the snap fasteners 458 to attach the tabs 464 to the front panel 404, holding the hood 460 in position. In this matter, shade or rain/snow protection can be provided to the pet riding in the backpack 400.

While snap fasteners 458 and 456 are described and shown here, other fasteners can also be used, such as buttons, magnetic fasteners, hook and loop fasteners, and the like. Further in some examples, the hood 460 may not be permanently attached to the backpack 400. Instead, the hood 460 can be fastened to the backpack 400 via fasteners or a zipper.

Harness

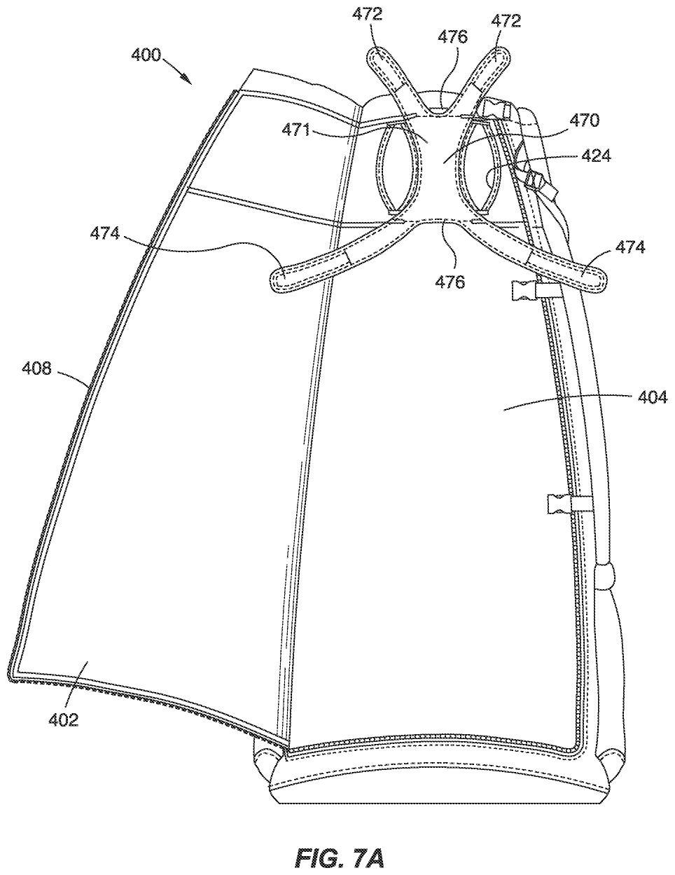

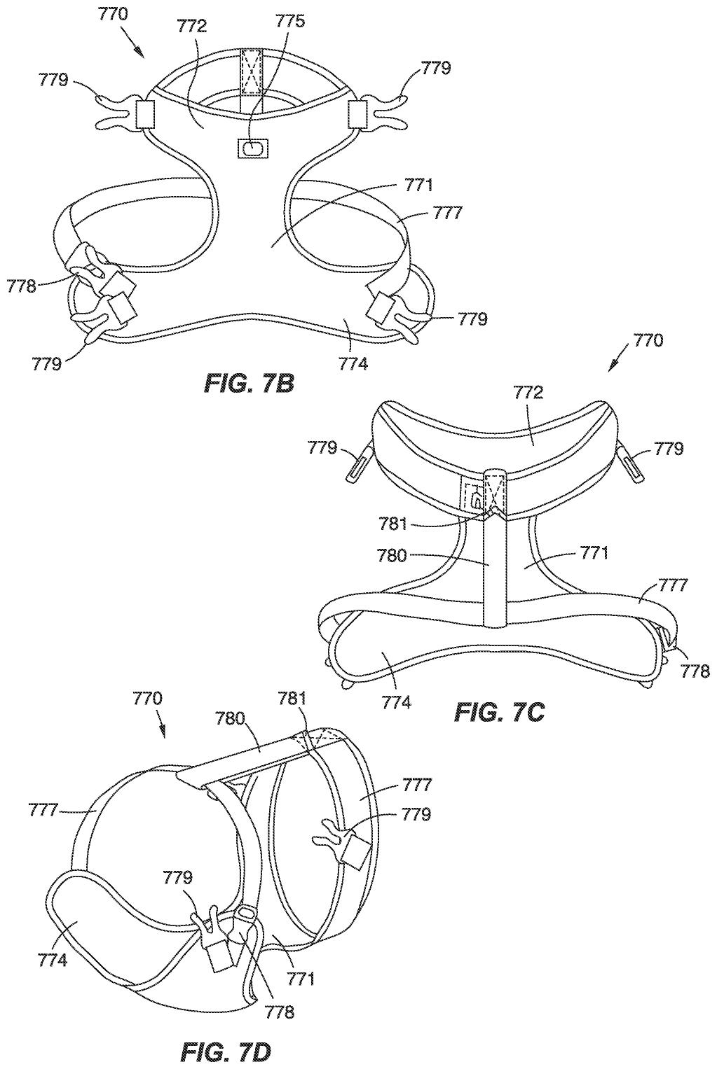

FIG. 7A shows an interior of a front-facing, pet-carrying backpack, according to one example of the present disclosure. Here, the backpack 400 is shown with the zipper 408 unzipped and the rear panel 402 folded away from the backpack 400 revealing the interior of the backpack 400. Between the paw holes 424, a harness 470 is attached to the backpack 400. More specifically, the harness 470 is attached such that the chest portion 471 of the harness 470 is placed between the arm holes 424.

The harness 470 can be sewn into the design of the backpack 400 to be permanently attached, such as via seams 476. In other examples, the harness 470 can be removable to be worn by the pet outside of the backpack 400 as well as in. When the harness 470 is removed, the harness 470 can be placed onto the pet prior to loading the pet into the backpack 400. In one example of a removable harness 470, the harness 470 can have a plastic turn fastener that extends through a hole in the front panel 404 of the backpack that twists to lock to the harness in place. However, this is just one example of a connection mechanism and other connection mechanisms can be used.

The harness 470 can be configured to have two upper attachment straps 472 and two lower attachment straps 474. The upper attachment straps 472 extend over the neck/shoulders area of the pet and fasten together, such as using a buckle type fastener, snaps, pinch clip, hook and loop, or any other desirable fastener. The lower attachment straps 474 extend under the forelegs of the pet and around the torso area of the bet and fasten together.

FIGS. 7B, 7C, and 7D show another example of a harness compatible with a pet carrying backpack. Here, a harness 770 is shown having a chest portion 771. The harness 770 is removable and includes a turn fastener 775 that extends through a corresponding aperture in a pet-carrying backpack. The harness 770 has an upper attachment loop 772 that extends over the neck/shoulder area of the pet. The loop 772 can be configured to be pulled over the head of the head of the pet, or it can include a fastener to releasably attach around the neck/shoulder area of the pet, such as a hook-and-loop fastener, a buckle, a clip, etc.

The harness 770 further includes lower attachment portions 774. A lower strap 777 is attached to one of the lower attachment portions 774 and is configured to extend around the back of the pet and attach to the other lower attachment portion 774 such as via a clip fastener 778. A stability strap 780 can extend from the lower strap 777 to the upper attachment loop 772.

In this example, the harness 770 is configured to accommodate a storage bag (not shown). In some instances, it can be desirable for a larger dog to carry a storage bag when the dog is not in the backpack. The harness 770 includes bag attachment clips 779 attached to both the upper attachment loop 772 and the lower attachment portion 772. To provide further stability a loop 781 is provided on the stability strap 780. The clips 779 and loop 781 attach to the storage bag to securely hold the storage bag relative to the harness 770.

The removable or permanently attached harness 470, 770 provides several advantages. When the pet wears the harness 470, 770 in the backpack 400, the pet cannot pull out of the backpack 400 if it is spooked, increasing the safety for the pet and the user. Further, the harness 470, 770 helps to support the weight of the pet, taking weight off of the hind legs of the pet. This increases the comfort of the pet, and also increases the duration of the time that the pet can spend in the backpack 400. The harness 470, 770 also keeps the pet toward the front of the backpack 400 while the backpack 400 is worn by the user. This provides better balance and makes the backpack 400 easier to wear while carrying a pet.

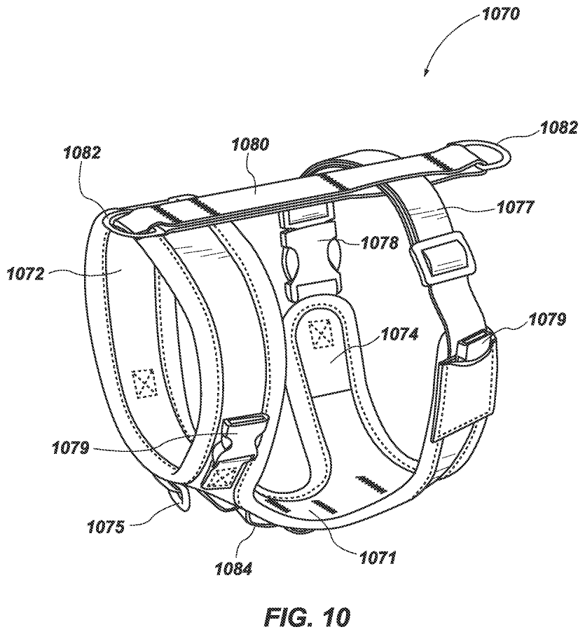

FIG. 10 shows another example of a pet harness that can be used with a pet-carrying backpack. A pet harness 1070 is similar to harnesses 470, 770 in many ways and can be used by a pet independently or along with a pet carrying backpack, such as those examples described herein. The pet harness 1070 can comprise a chest portion 1017 that is configured to run along a pet's chest between its forelegs when the pet harness 1070 is worn by the pet.

At a front side of the harness 1070, the harness 1070 can comprise an attachment mechanism in the form of an attachment ring 1075. The attachment ring 1075 can be operable as an attachment point to which the harness can attach to an interior of a pet carrying backpack (such as those described herein). For example, a clip, such as a carabiner clip, disposed on an interior of a pet carrying backpack (such as on an inside of a front panel 104 of pet carrying backpack 100, for example) can attach to the attachment ring 1075. Such a clip can be disposed near a collar portion of the backpack between the paw holes (such as near collar 110 of the backpack 100 between paw holes 124) to correctly position the pet within the backpack, for example to position the forelegs of the pets to align with the paw holes of the pet carrying backpack.

The harness 1070 can have an upper attachment loop 1072. The upper attachment loop 1072 can extend over and around the neck/shoulder area of the pet. The loop 1072 can be configured to be pulled over the head of the head of the pet, or it can include a fastener to releasably attach around the neck/shoulder area of the pet, such as with a hook-and-loop fastener, a buckle, a clip, etc.

The harness 1070 can further include a lower attachment portion 1074 and a lower strap 1077. The lower strap 1077 can be attached to the lower attachment portion 1074 and can extend around the back of the pet. The lower strap 1077 can attach to the lower attachment portion 1074 via a clip fastener 1078. A stability strap 1080 can extend from the lower strap 1077 to the upper attachment loop 1072 and can run along a back of the pet when the harness 1070 is worn by the pet.

The harness 1070 can include various other features. For example, the harness 1070 can be configured to carry one or more accessories. In this example, the harness 1070 can comprise accessory attachment clips 1079. The accessory attachment clips 1079 can allow accessories to be clipped to the harness, such as a clip-on bag, as described in more detail below. The harness 1070 can also comprise attachment rings 1082. In this example, the attachment rings 1082 are disposed on both sides of the stability strap 1080. The attachment rings 1082 can allow a user to attach a leach or other item to the harness 1070. Loops 1084 can also be provided along the checks portion 1071 of the harness 1084 to facilitate other accessories or to secure the pet within a pet carrying backpack.

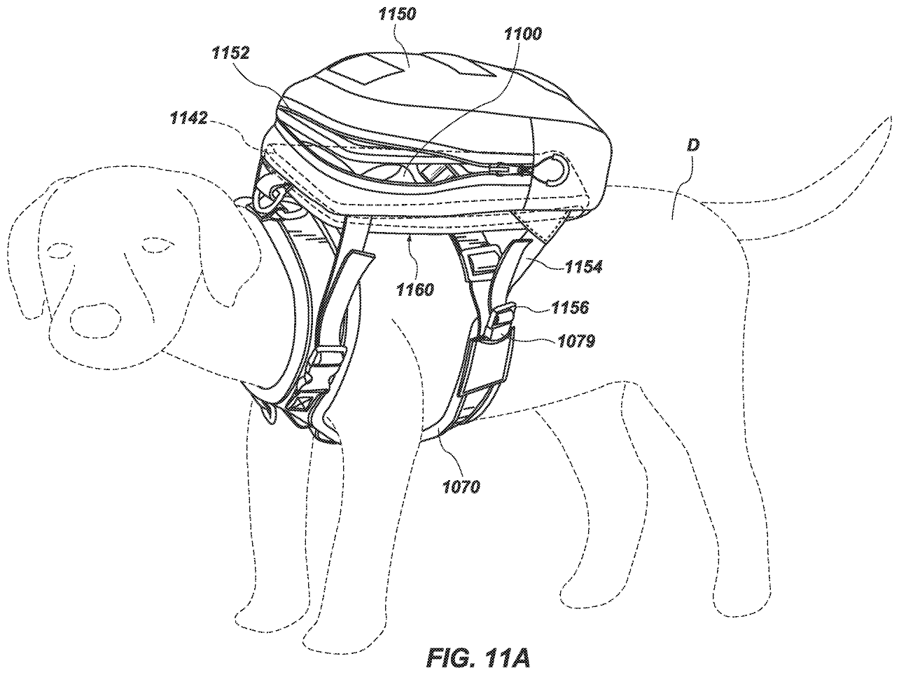

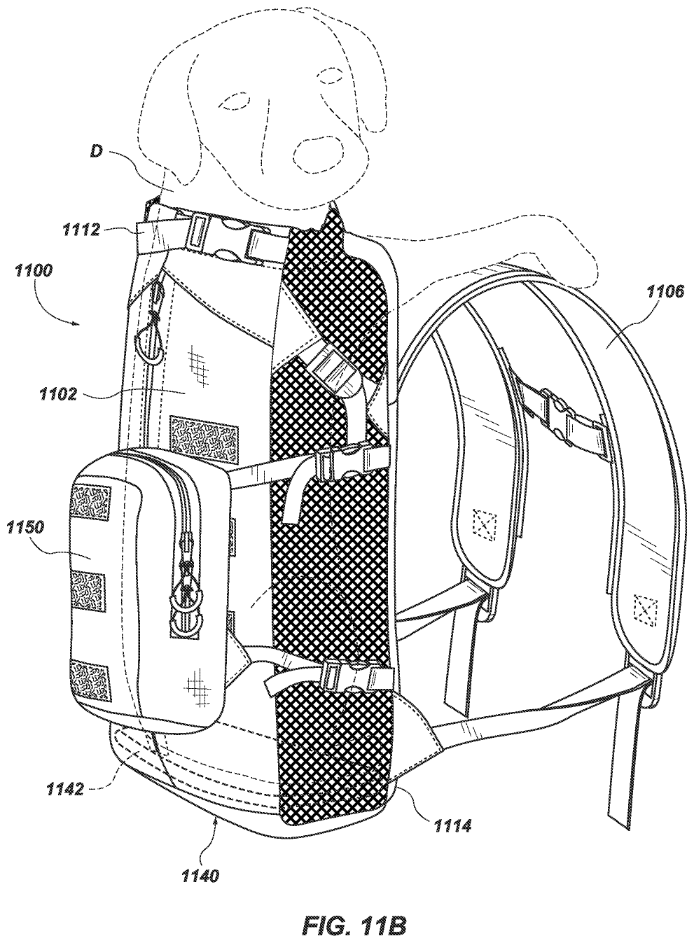

FIG. 11A shows a pet wearing a pet harness and carrying a clip-on bag, and FIG. 11B shows a pet being carried within a pet carrying backpack. In some instances, a pet owner desired to bring a pet on a walk, hike, or other similar outing. However, a distance of the outing might be beyond the physical abilities of the pet, such as due to age or other physical condition. In this instance, the pet owner can utilize one or more of the examples of a pet carrying backpack as described herein. However, both the pet and the owner may still desire that the pet walks or runs at least during part of the outing. In this instance, the pet owner desires an ability to carry the pet during one or more parts of the outing.

The harness 1070 can facilitate a pet being able to walk for a portion of an outing and being able to be carried by an owner for a portion of an outing. As mentioned above, the harness 1070 can be configured to carry one or more accessories. In this example, the accessory attachment clips 1079 are used to selectively and releasably attach a clip-on bag 1150 to the harness 1070. The clip-on bag 1150 can comprise an opening 1152 to access an inner compartment of the clip-on bag 1150. The clip-on bag 1150 can comprise straps 1154 and clips 1156 that selectively and releasably attach to the accessory attachment clips 1079 of the harness 1070.

The clip-on bag 1150 can be sized to pack a pet carrying backpack 1110 therein. In this manner, the pet, such as the dog D shown in FIG. 11A, can carry the pet carrying backpack 1100 during the portion of the outing that the pet walks. When the pet becomes tired, or when any other condition dictates that the pet should be carried, the pet carrying backpack 1100 can be removed from the clip-on bag 1150, and the pet, such as the dog D, can be placed into the pet-carrying backpack 1100 to be carried by the user as shown in FIG. 11B. The combination of the harness 1070 and the pet carrying backpack 1100 can be considered a system for walking and carrying a pet.

The pet carrying backpack 1100 can be similar to other backpack described herein. The pet carrying backpack 1100 is constructed of thin, lightweight, and strong materials that can be easily compressed into the clip-on bag 1070 while also having sufficient strength to safely carry a pet in a pet carrying compartment formed in the pet carrying backpack 1100. When the pet is placed in the pet-carrying backpack 1100, the clip-on bag 1150 is configured to be selectively and releasably attached adjacent to the back panel 1102 of the backpack 1100.

The pet carrying backpack 1100 and the clip-on bag 1150 are sized to each accommodate a pad 1142 (see FIGS. 11A and 11B). When the pet is placed into the pet carrying backpack 1100, the pad is disposed on the interior of the pet carrying backpack 1100 adjacent to the bottom panel 1140 of the pet carrying backpack 1100. In other backpacks where there is a storage compartment below a pet carrying compartment such as in backpack 300 described above, the pad is placed at a bottom of the pet carrying compartment. The pad 1140 is sized to securely fit into the backpack 1100, such as to extend to both ventilation ports 1114 on each side of the backpack 1100. In this manner, the pad can provide structure to the pet carrying backpack that is otherwise collapsible to fit within the clip-on bag. This supports the pet securely and comfortably within the pet carrying backpack 1100.

When the pet is carrying the pet-carrying backpack 1100 in the clip-on bag 1150, the pad 1142 is sized to fit securely into the clip-on bag adjacent to a front panel 1160 of the clip-on bag. The pad 1142 thus can protect the pet from being poked by pads, straps, and/or zippers on the backpack 1100 while it is stored in the clip-on bag 1150 and carried by the pet.

Convertible Pen

When pet owners transport pets by carrying them, such as by using a pet-carrying backpack 100, 300, 400 described herein, they may find that they need to contain the pet at a destination. For example, after carrying a pet to a restaurant, airport, or other public place, it may be best that the pet remained confined to a certain area to avoid spooking the pet or to prevent the pet from contacting people in the area who may have pet allergies from the pet. On the other hand, portable pet pens have been used by pet owners to contain pets in public places, but such pens may be hard to carry with the pet riding therein.

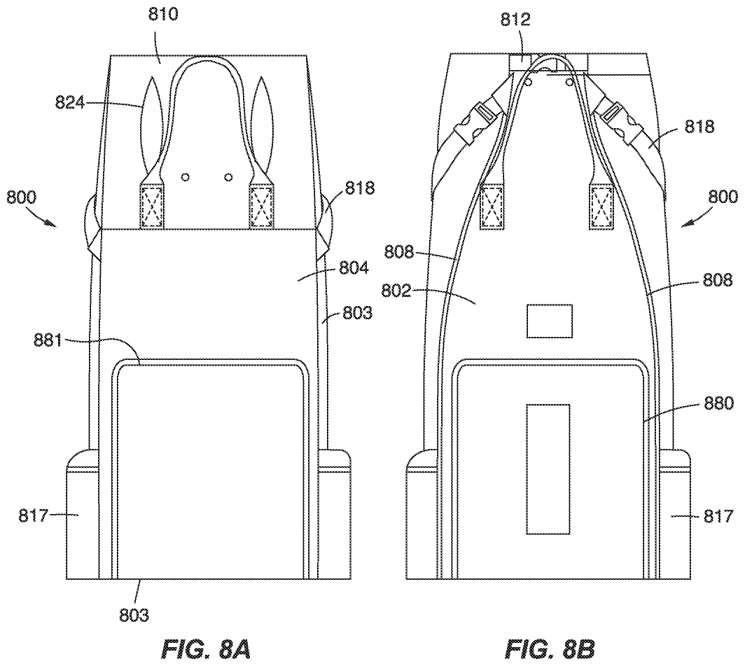

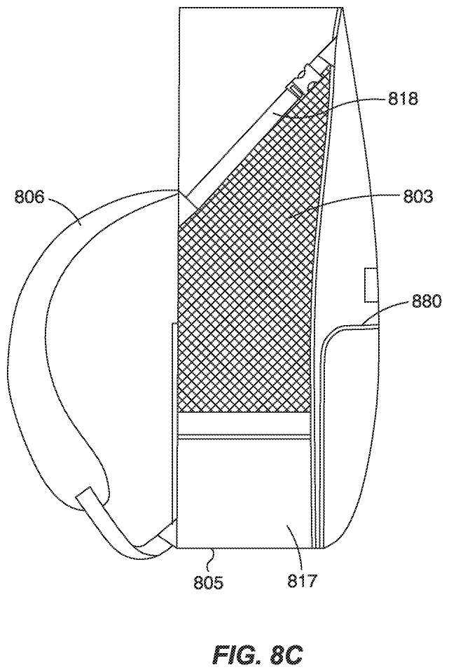

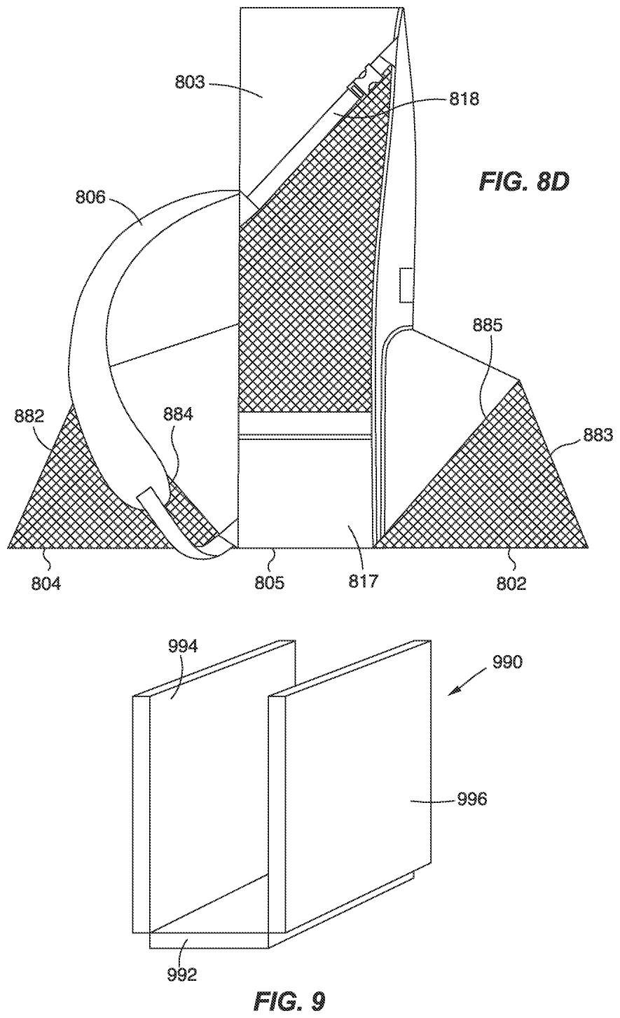

FIG. 8A, FIG. 8B, FIG. 8C, and FIG. 8D show examples of a front-facing pet carrying backpack that is convertible to a travel pet pen, according to one example. As shown in FIGS. 8A and 8B, a front-facing, pet-carrying backpack 800 comprises a front panel 804, a rear panel 802, and side panels 803. Shoulder straps 806 are attached to the front panel 804 to allow the user to wear the backpack 800 on his/her back (not shown in FIG. 8A so that other features can more easily be shown. See FIG. 8C). Paw holes 824 are disposed above the shoulder straps 806 on the front panel 804. When a pet sits in the backpack 800, the pet's paws can extend through the paw holes 824.

The backpack 800 comprises a collar 810 on the top of the backpack 800. The collar 810 extends around the pet's neck during use and is adjusted by the collar strap 812. In this example, two access zippers 808 are disposed on the rear panel 802. When the access zippers 808 are unzipped, the rear panel 802 can be folded downwards and away from the backpack 800 so that a pet can walk to and lie down in the interior of the backpack 800, such as by lying down and resting against the interior side of the front panel 804, for loading.

The backpack 800 can include other accessories such as pockets. For example, several rear pockets can be disposed on the rear panel 802 of the backpack 800 to provide flexible storage options to the user. The pockets can be sewn onto the rear panel 802 or can be attached in any suitable manner. The pockets can include zippers to close the pockets or other fastening mechanisms.

As shown in FIG. 8C, the side panels 803 can comprise side storage pockets 817 for added storage. The side panels 803 can be formed from a mesh material to allow ventilation into the interior of the bag to help regulate a pet's temperature. In some examples, the side panel can also include a fabric cover over the mesh with a vent access zipper to selectively open and close the side panel 803 to expose the mesh lining. When the zipper is open, air can flow through the lining to cool a pet riding therein. Adjustment straps 818 are also provided along the side panel 803 as shown to adjust the interior space of the backpack 800 to accommodate differently sized pets.

Returning to FIGS. 8A and 8B, the backpack 800 further comprises a front pen release zipper 881 disposed on the front panel 804 of the backpack 800 and a rear pen release zipper 880 disposed on the rear panel of the backpack 800. The front pen release zipper 881 extends from the bottom of the backpack 800 near one side panel 803 towards the top of the backpack 800 under the shoulder straps 806 and down the other side. The front pen release zipper 881 can extend to any desirable height on the front panel 804 based on the size of the convertible pet pen desired. Similarly, the rear pen release zipper 880 extends from the bottom of the backpack 800 near one side panel 803 towards the top of the backpack 800 to under the collar 810 and down the other side. The rear pen release zipper 881 can extend to any desirable height on the rear panel 802 based on the size of the convertible pet pen desired. The rear pen release zipper 880 is disposed on the rear panel 802 just inside the two access zippers 808 as shown in FIG. 8B.

The front and rear pen release zippers 880, 881 are configured to release a pet pen. As shown in FIG. 8D, when the front pen release zipper 881 is unzipped, at least a portion of the front panel 804 folds away from the side panels 803 deploying a front pen portion 882 of the pet pen. The front pen portion 882 can be formed from a mesh material that allows the pet to see out and provides ventilation to the front pen portion 882 while being sufficiently strong to retain the pet within the front pen portion 882 of the pet pen. The structure of the front pen portion 882 can be formed by flexible poles 884, such as those used in lightweight tents. The flexible poles 884 are placed in the front pen portion 882 at periodic intervals to form the supporting structure of the front portion 882 of the pet pen. For example, sleeves can be formed in the material of the front pen portion 882 of the pet pen in which the poles 884 are inserted.

The front panel 804 can be formed to include or accommodate a thick, padded material such that when the front pen portion 882 is deployed and the front panel 804 rests on a flat surface, the front panel 804 provides a comfortable surface for the pet to be on. The inside of the front panel 804 can comprise a coating, such as a polyurethane coating to provide a waterproof barrier.

When the rear pen release zipper 880 is unzipped, at least a portion of the rear panel 802 folds away from the side panels 803 deploying a rear pen portion 883 of the pet pen. The rear pen portion 883 can be formed from a mesh material that allows the pet to see out and provides ventilation to the rear pen portion 883 while being sufficiently strong to retain the pet within the front portion 882 of the pet pen. The structure of the rear pen portion 883 can be formed by flexible poles 885, such as those used in lightweight tents. The flexible poles 885 are placed in the rear pen portion 883 at periodic intervals to form the supporting structure of the rear pen portion 883 of the pet pen. For example, sleeves can be formed in the material of the rear pen portion 883 of the pet pen in which the poles 885 are inserted.

The rear panel 802 can be formed to include or accommodate a thick, padded material such that when the rear pen portion 883 is deployed and the rear panel 802 rests on a flat surface, the rear panel 802 provides a comfortable surface for the pet to be on. The inside of the rear panel 802 can comprise a coating, such as a polyurethane coating to provide a waterproof barrier.

FIG. 9 shows a base padding for a convertible pet backpack and pen, according to one example of the present disclosure. A base padding 990 can include a bottom portion 992, a first side portion 994, and a second side portion 996. The base padding 990 can be formed from any suitable material to provide support and padding for a pet. The base padding 990 is configured to be disposed in the bottom panel 805, front panel 802, and rear panel 804 of the backpack 800 (see FIGS. 8A-8D). When the front and rear pen portions 882, 883 of the pet pen are deployed, the side panels 994, 996 fold down flat adjacent to the bottom panel 992 to form a comfortable pad on which a pet can rest. The size and shape of the panels 992, 994, 996 can vary based on the size and shape of the bottom panel 805 of the backpack 800 and the portions of the front and rear panels 802, 804 which deploy as the pet pen.

The backpack 800 provides several benefits to the user. The user can carry a pet similar to backpacks 100, 300, 400 while also providing a safe comfortable enclosure for the pet upon arrival to a destination. The pet pen keeps the pet safe and secure while allowing the user to remove the backpack 800 so that the user does not have to constantly wear the carrier. Further, the pet can securely remain in the pet carrier at the destination while having the freedom to rest comfortably in a sitting or lying down position within the deployed pet pen.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for walking and carrying a pet comprising:
a harness configured to be worn by the pet;
a clip-on bag that is selectively attachable to and removable from the harness to be carried by the pet; and
a pet carrying backpack configured to be stored within the clip-on bag to be carried by the pet, and comprising a pet compartment configured to carry the pet.

2. The system of claim 1, wherein the harness comprises an attachment mechanism configured to attach to and detach from a front panel of the pet carrying backpack.

3. The system of claim 2, wherein the attachment mechanism is disposed on a chest portion of the harness.

4. The system of claim 1, further comprising a pad configured to be disposed within the clip-on bag to pad the pet from the pet carrying backpack stored therein and configured to be disposed within the pet compartment to support the pet seated therein.

5. The system of claim 1, wherein the pet carrying backpack comprises shoulder straps, an open top, and paw holes disposed on the backpack between the shoulder straps and the open top.

6. The system of claim 5, wherein the harness comprises a chest portion, the chest portion comprising an attachment mechanism, the attachment mechanism configured to attach to and detach from a front panel of the pet carrying backpack.

7. The system of claim 6, wherein the attachment mechanism attaches to the front panel between the paw holes.

8. The system of claim 1, wherein the pet carrying backpack comprises:
a bottom panel, a font panel, a rear panel, a right-side panel, and a left-side panel connected together to form a bag with an open top, the open top comprising a collar forming an opening which is configured to allow a head of the pet disposed within the bag to protrude therefrom, the collar being adjustable;
shoulder straps disposed on and extending from the front panel; and
paw holes disposed on a front of the backpack body above the shoulder straps and below the collar, the paw holes being configured to accommodate paws or legs of the pet.

9. The system of claim 1, wherein the clip-on bag is selectively attachable to and removable from the pet-carrying backpack.

10. A method for walking and carrying a pet, the method comprising:
fitting a harness onto a pet;
attaching a clip-on bag to the harness such that the pet carries the clip-on bag which is supported by the harness while the pet is walking;
removing a pet-carrying backpack from the clip-on bag; and
inserting the pet into the pet carrying backpack such that the pet is carried in the pet-carrying backpack.

11. The method of claim 10, wherein inserting the pet into the pet carrying backpack further comprising attaching the harness to the pet carrying backpack via an attachment mechanism.

12. The method of claim 11, wherein the attachment mechanism is disposed on a chest portion of the harness.

13. The method of claim 10, wherein a pad is disposed in the clip-on bag to be adjacent to the pet when the clip-on bag is supported by the harness while the pet is walking, and wherein inserting the pet into the pet carrying backpack comprises removing the pad from the clip-on bag and placing the pad into the pet-carrying backpack such that the pet sits on the pad while being carried in the pet-carrying backpack.

14. The method of claim 10, wherein the pet carrying backpack comprises shoulder straps, an open top, and paw holes disposed on the backpack between the shoulder straps and the open top, and wherein inserting the pet into the pet carrying backpack comprises leading paws or legs of the pet through the paw holes.

15. The method of claim 14, wherein the harness comprises a chest portion and the chest portion comprises an attachment mechanism, and wherein the inserting the pet into the pet carrying backpack comprises attaching the attachment mechanism to a front panel of the pet carrying backpack.

16. The method of claim 15, wherein the attachment mechanism attaches to the front panel between the paw holes.

17. The method of claim 10, wherein the pet carrying backpack comprises:
a bottom panel, a front panel, a rear panel, a right-side panel, and a left-side panel connected together to form a bag with an open top, the open top comprising a collar forming an opening which is configured to allow a head of the pet disposed within the bag to protrude therefrom, the collar being adjustable;
shoulder straps disposed on and extending from the front panel; and
paw holes disposed on a front of the backpack body above the shoulder straps and below the collar, the paw holes being configured to accommodate paws or legs of the pet.

18. The method of claim 10, further comprising removing the clip-on bag from the harness and attaching the clip-on bag to the pet-carrying backpack.

19. A system for walking and carrying a pet comprising:
a pet carrying backpack comprising a pet carrying compartment to carry a pet therein; and
a harness configured to be worn by the pet, the harness comprising an attachment mechanism operable to attach to and detach from the pet carrying compartment.

20. The system of claim 19, wherein
the pet carrying backpack comprises shoulder straps, an open top, and paw holes disposed on the backpack between the shoulder straps and the open top, and
the harness comprises a chest portion, the chest portion comprising the attachment mechanism.
